(19) United States
(12) Patent Application Publication
(10) Pub. No.: US 2008/0271281 A1
(43) Pub. Date: Nov. 6, 2008

(54) Loose Material Collecting Device and Method

(75) Inventors: Donald R. Wittkowski, Sullivan, IL (US); Danney Dendy, Sullivan, IL (US)

Correspondence Address: VEDDER PRICE P.C., 222 N. LASALLE STREET, CHICAGO, IL, 60601, US

(73) Assignee: AGRI-FAB, INC., Sullivan, IL (US)

(21) Appl. No.: 11/744,678

(22) Filed: May 4, 2007

(51) Int. Cl. A01D 90/00

(52) U.S. Cl. 15/340.1

(57) ABSTRACT

The present disclosure relates generally to a device for collecting and transporting loose material, and in particular, to a device pulled by a vehicle equipped with a turbine, a conduit, an enclosure, and a foldable accordion-type top. This device is equipped with a top made of a plurality of foldable rectangular ribs over which a flexible sheet and air opaque or mesh-line panels are used to regulate the flow of air through the enclosure. At one end the sheet is secured to the loose material conduit where loose material enters the enclosure and at an opposite end the sheet is secured to the tailgate or to the back section of the enclosure. To open the enclosure with a tailgate equipped with this disclosure, a user unlocks the tailgate of the enclosure, flips the back section of the accordion-type roof up toward the front section, and secures the tailgate to the folded accordion-type roof. To open the enclosure without a tailgate equipped with this disclosure, a user unlocks the back section of the accordion-type roof from the back of the enclosure and flips the back section of the accordion-type roof up toward the front section, and secures the locking mechanism to the roof.

### FIELD OF THE DISCLOSURE

The present disclosure relates generally to a device for collecting and transporting leaves, cut grass, small sticks, pine needles, wood chips, and other loose material (hereinafter referred to as “loose material”) and, in particular, to a device pulled by a vehicle equipped with a turbine., a conduit, an enclosure, and a foldable accordion-type top.

### BACKGROUND

Loose material is generally collected from a surface area such as a garden using a device equipped with a fan, a blower, or another type of air-circulating device. Rapid airflow above loose material creates a depression lifting the loose material from the surface area and then dragging the loose material along the path of the airflow to a new location where it may be collected or processed. In addition to rapid airflow-based systems, other collecting devices may use a mechanical lifting device such as a rotating brush or the like.

There are three main categories of loose material collection devices. A first type creates and processes loose material, such as a lawnmower that cuts grass or shreds leaves on the surface area. A second type processes and collects loose material like a tractor lawnmower equipped with a collection or bagging device. A third category serves only to collect loose material, either as an attachment to a device from the first category or as a stand-alone collector of loose material. Devices that process and collect loose material are generally unable to simply collect without activating the processing means. For instance, a device such as a lawnmower tractor cannot collect leaves without activating the lawn cutting rotor. Devises directed at collecting loose material are generally equipped with a collection system such as a blower, a turbine, a fan, or the like connected to an enclosure.

Most collection devices store loose material in an enclosure that must ultimately be emptied by the user. To increase capacity, larger enclosures are preferred. But with increased enclosure volume, problems arise that include weight, portability, removal access, and storage. For large enclosures, such as one located on a cart pulled by a tractor, increased accessibility is also needed without adversely affecting the size of the enclosure. An operator must be able to empty the enclosure, often filled with compacted and loose, humid matter, using a lawn tool such as a rake or a shovel.

Currently, loose material collecting devices are equipped with rigid covers, and limited rear access is made via a hinged door or an opening in the enclosure. FIG. 1 shows Craftsman Model #24505, a first relevant model found in the prior art. FIG. 1 is a schematic perspective view of the enclosure equipped with a thick, fixed fabric cover. Access to the interior is enabled via a back door, where the fabric is unzipped along an opening such as a semicircle. The fabric is attached to a fixed armature, and understandably, rear access is impeded by the partial opening and the possibility of damaging the closing mechanism using lawn tools during emptying operations. FIG. 2 shows Agri-Fab, Inc. Mow-n-Vac Model #501886, a second relevant model found in the prior art. FIG. 2 is a schematic perspective view of a second existing loose material collecting device equipped with a hard top made of rigid plastic. Access to the interior of this second enclosure is enabled via a back door secured by clips. Again, users access the loose material through a limited aperture and use of lawn tools during emptying may damage the opening.

Other types of loose material collecting devices may be configured without a back door but have a back panel with an obtuse angle that contacts with the ground once the enclosure is rotated back around its fixation axis. A version of this type of material collecting device by Agri-Fab, Inc., is disclosed as Design Patent Application No. 29/207,379 and is hereby incorporated fully by reference.

What is desired is a device that provides improved access to the enclosure interior in order to better access the loose material and reduce the time needed to empty the enclosure. A new, improved device must also protect the closing mechanism of the enclosure from wear and tear by a user using lawn tools, if such a closing mechanism is present. Finally, it would be a distinct improvement if the loose material, when humid, could be dried by the sunlight simply by opening the enclosure and placing the enclosure in a temporary storage place in order to reduce the weight of the loose material and thus further reduce processing time.

Although many of these devices are able to perform their intended functions in a workmanlike manner, none of them solve all of these drawbacks. What is needed is a loose material collection device that allows for better access to the enclosure interior, allows for sun drying of the loose material while the enclosure is temporarily stored, and is designed with a built-in enclosure opening protection system. The present invention solves these and many other problems associated with currently available loose material collecting devices.

### SUMMARY

The present disclosure relates generally to a device for collecting and transporting loose material, and in particular, to a device pulled by a vehicle equipped with a turbine, a conduit, an enclosure, and a foldable accordion-type top.

This device is equipped with a top made of a plurality of foldable rectangular ribs over which a flexible sheet is secured. The flexible sheet may comprise mesh-like portions able to direct the airflow through the enclosure while retaining the loose material within the enclosure. At one end the sheet is secured to the loose material conduit where loose material enters the enclosure and at an opposite end the sheet is secured to the tailgate or to the back section of the enclosure. To open the enclosure with a tailgate equipped with this disclosure, a user unlocks the tailgate of the enclosure, flips the back section of the accordion-type roof up toward the front section, and secures the tailgate to the folded accordion-type roof. To open the enclosure without a tailgate equipped with this disclosure, a user unlocks the back section of the accordion-type roof from the back of the enclosure and flips the back section of the accordion-type roof up toward the front section, and secures the locking mechanism to the roof.

In an open configuration, a closing mechanism is moved away from the unloading area of the loose material, thus protecting a tailgate from user wear and tear. Most of the loose material within the enclosure is given access to sunlight for improved drying. Generous access to the enclosure interior is granted to aid in the removal of the loose material by the operator.

### BRIEF DESCRIPTION OF THE DRAWINGS

FIG. 1 is a simplified perspective illustration of Craftsman Model #24505 equipped with a fixed fabric cover.

FIG. 2 is a simplified perspective illustration of Agri-Fab, Inc. Mow-n-Vac Model #501886 equipped with a hard plastic cover.

FIG. 3 is an exploded perspective view of the inventive loose material collecting device with an accordion-type cover.

FIG. 4 is a side view of the loose material collecting device equipped with an accordion-type cover in closed position.

FIG. 5 is a side view of the loose material collecting device equipped with an accordion-type cover in the open position.

FIG. 6 is a simplified perspective illustration of the flexible sheet of the enclosure according to another embodiment.

FIG. 7 is a flow chart that schematically illustrates the steps of the method for collecting, storing, and removing loose material from the loose material collecting device.

### DETAILED DESCRIPTION

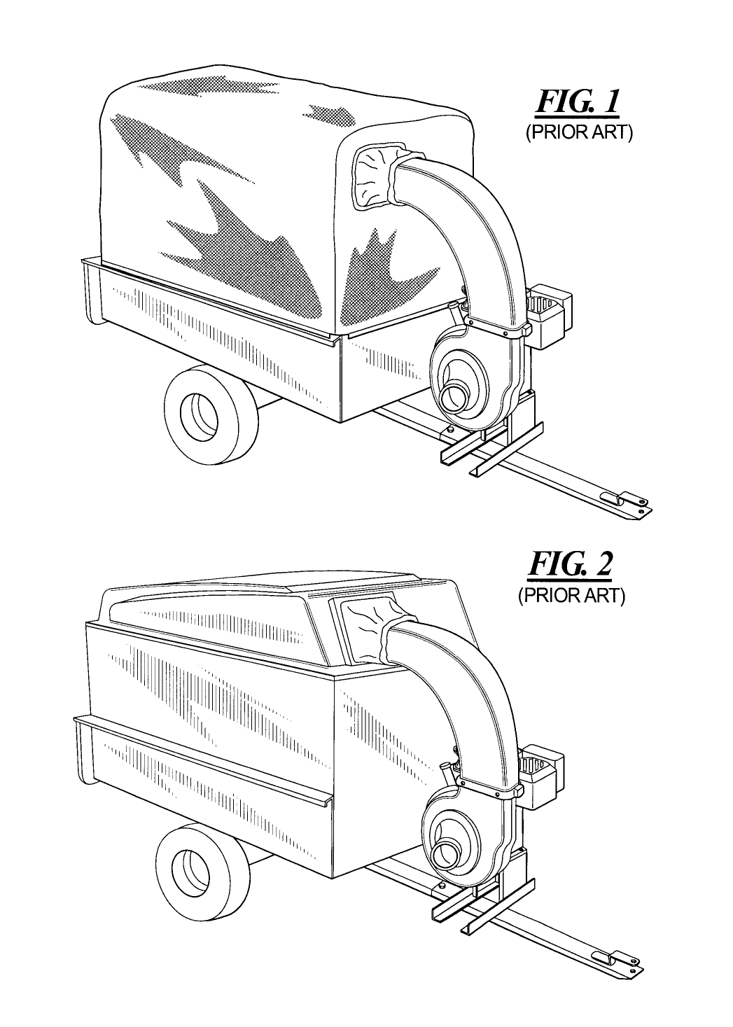

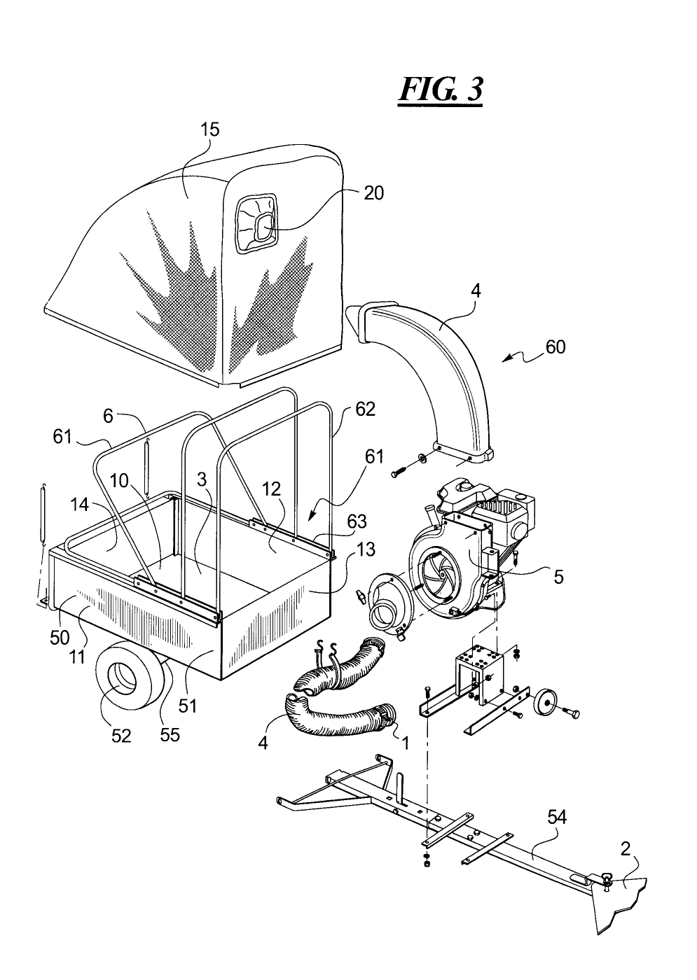

The disclosure describes a device that may be used to collect and transport loose material. FIGS. 1 and 2 illustrate the current state of the art. Two devices are shown: Craftsman Model #24505 equipped with a fixed fabric cover, and Agri-Fab, Inc. Mow-n-Vac Model #501886 equipped with a hard plastic cover, respectively. In contrast, FIG. 3 shows a first embodiment of the present disclosure as it contrasts with the existing prior art.

FIG. 3 shows a device to be used, preferably in the back of a tow vehicle 2, for collecting and temporarily storing loose material 60. The device comprises a head member 1 for receiving loose material from the towing vehicle 2, an enclosure 3, a loose material conduit 4 for transferring the loose material from the head member 1 to the enclosure 3, and a turbine 5 for creating suction in the head member 1 and the loose material conduit 4, the turbine 5 being disposed between the head member 1 and the enclosure 3, wherein the enclosure 3 includes an accordion-type top panel 6.

FIG. 3 illustrates one of the preferred embodiments where the turbine is a centrifugal fan driven by a 5.5-horsepower engine, but it is understood by one of ordinary skill in the art that a plurality of different driving force apparatuses or turbines may be used, such as a radial fan, a tangential fan, a blower, a wind-driven conveyor belt, or the like. In addition, while a 5.5-horsepower engine is disclosed in the preferred embodiment, it is understood that turbine blower driving mechanisms are designed to optimize the suction force within the loose material conduit based on the desired speed and distance of travel of the loose material in order to transport the loose material from the head member 1 to the enclosure 3. A plurality of factors are generally optimized in an attempt to reduce the amount of power required to create the desired suction, such as the type of loose material conduit, the surface roughness of the inside of the conduit, the geometry of the air travel, the difference in height between the head member 1 and the enclosure 3, and the like.

It is understood by one of ordinary skill in the art that while FIG. 3 illustrates a preferred embodiment where the upstream conduit from the turbine 5 is a flexible, cylindrical tube attached with clip-like connectors and the downstream section of the conduit is a rigid conduit attached with rigid fixation means such as bolts, other possible configurations where a rigid or flexible single loose material conduit 4 is used, or any other combination of flexible or rigid loose material conduit 4 in conjunction with a turbine 5, is conceived.

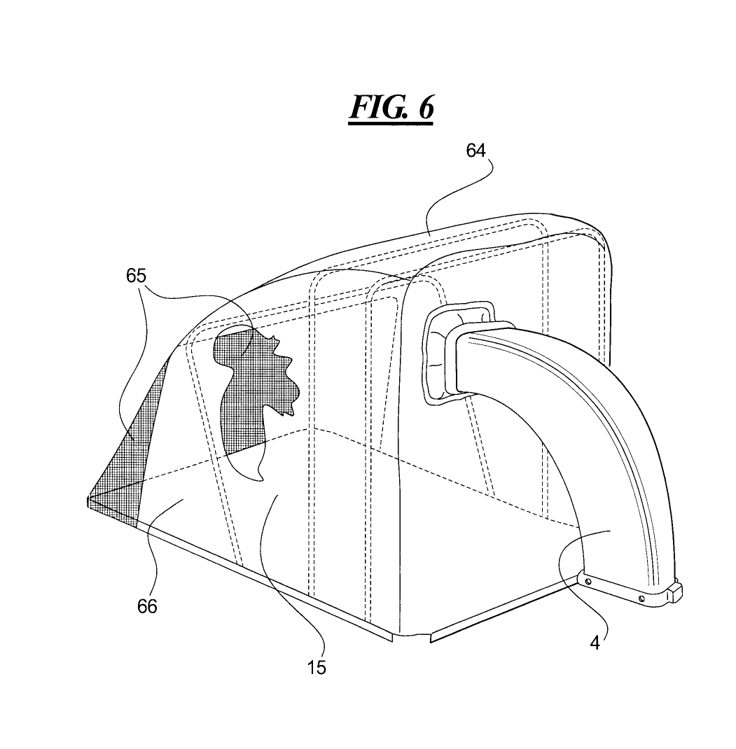

The accordion-type panel 6 is made of a frame 61 further comprising a series of rectangular arches 62 pivotally connected on each lateral side to support rails 63. A flexible sheet 15 equipped with an opening 20 is secured to the frame using any regular fixation means, such as flaps, stitches, glue, rivets, magnets, and the like. In the preferred embodiment, four rectangular arches 52 are secured to two lateral side support rails 63 via a pivotal securing means. In another embodiment illustrated in FIG. 6, the flexible sheet 15 is equipped with an air opaque panel 66 and a mesh-like panel 65 allowing the flow of air through the enclosure 3 arriving from the loose material conduit 4 to be channeled in specific directions. It is understood by one of ordinary skill in the art that while an air opaque panel 66 and a mesh-line panel 65 are shown, other possible arrangements of air opaque panels are contemplated including but not limited to panels made of a first layer of mesh-line panel covered by an air opaque panel 64. Returning to FIG. 3, it is understood by one of ordinary skill in the design of flexible, accordion-type roof panels that a varying number of arches and lateral support rails can be used based on either the length and width of the enclosure 3 or other factors. The flexible sheet as shown in FIG. 5 creates flaps in the fully closed position, but it is understood by one of ordinary skill in the art that a plurality of flexible material with different properties may be used, including stretch material such as plastic, rubber, nylon, or other material that would result in limiting the folds between successive arches 62.

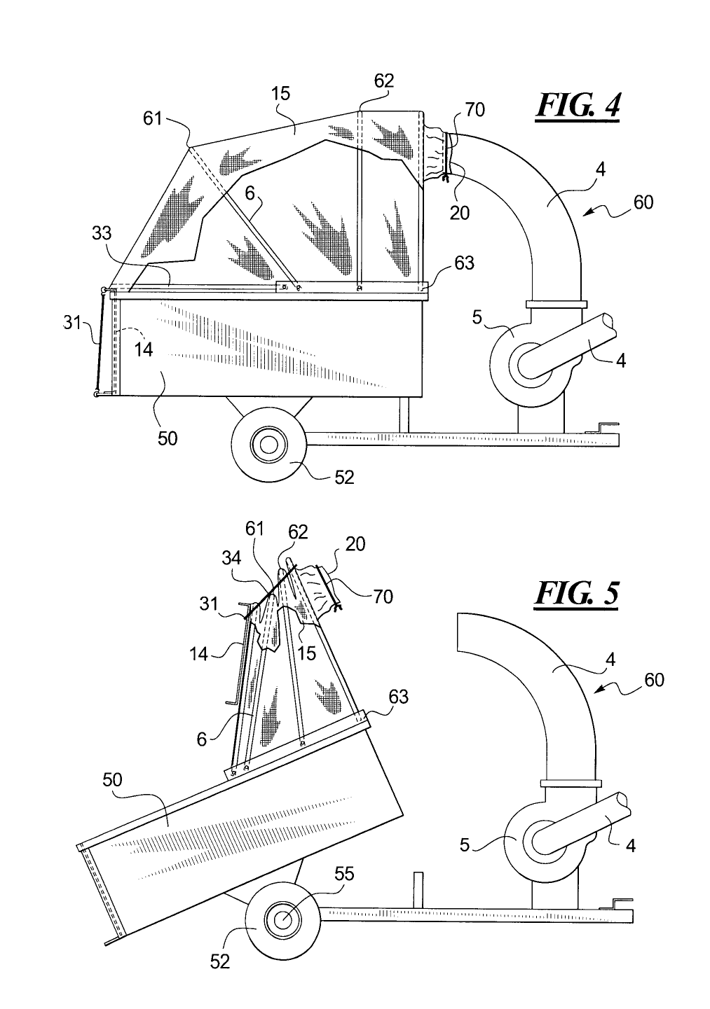

FIG. 4 illustrates the disclosure with the accordion-type top panel in the fully closed position while FIG. 5 illustrates the disclosure with the accordion-type panel in a fully open position with the enclosure tilted backwards to facilitate removal of loose material from within the enclosure 3. As shown in FIG. 4, the opening 20 in the flexible sheet 15 is secured to the loose material conduit 4 by a mechanical closing device 70 such as a flexible rope, a flexible elastic band, a circular clip, or the like. A second closing device 31 also made of a flexible rope, a flexible elastic band, or other simple mechanical device able to quickly secure a first part of the tailgate 14 in the fully closed configuration to secure the tailgate 14 to the enclosure 3 and in the fully open configuration to secure the tailgate to the accordion-type panel 6 as illustrated in FIG. 5. In a preferred embodiment, the tailgate 14 is attached to the flexible sheet 15 and a rectangular arch 62. In a configuration (not shown) where the enclosure does not have a tailgate but only has a back section of the enclosure 14, the second closing device 31 is secured to the back section of the enclosure 14 in the fully closed configuration and the same or another closing device is used to secure the rectangular arch 62 in the fully open configuration. It will be understood by one of ordinary skill in the art that while a configuration where the closure device is attached to the back section of the enclosure 14 is disclosed, any functionally equivalent method of fixation is contemplated, for example the disclosure of a long fixation device fixed to the bottom of the enclosure 3.

While FIG. 5 illustrates a situation where only the back section of the accordion-type roof 6 folds and attaches to the last rectangular arch 62, it is understood by one of ordinary skill in the art that the entire accordion-type roof may collapse forward, laterally, or may be rolled up according to a plurality of well-known configurations. What is disclosed is a foldable or retractable roof and a plurality of such flexible structures.

Returning to FIG. 3, the enclosure 3 may be mounted on a mobile cart 50 made of a frame 51, at least two wheels 52, and a towing arm 54. The enclosure is movable about a wheel axis 55 (not shown) to facilitate removal of the loose material. The enclosure 3 further comprises a bottom panel 10, two side panels 11, 12 attached to the side edges of the bottom panel 10, a front panel 13 attached to the front edge of the bottom panel 10, and a tailgate 14 or a back panel in a second embodiment attached to the edge of the accordion-type panel 6. While the preferred embodiment disclosed is a cart closely related to the prior art shown as FIGS. 1 and 2, it is understood by one of ordinary skill in the art that any possible cart configuration may be used, including a cart with different translation movement mechanisms, fixation systems, or geometries of the enclosure 3.

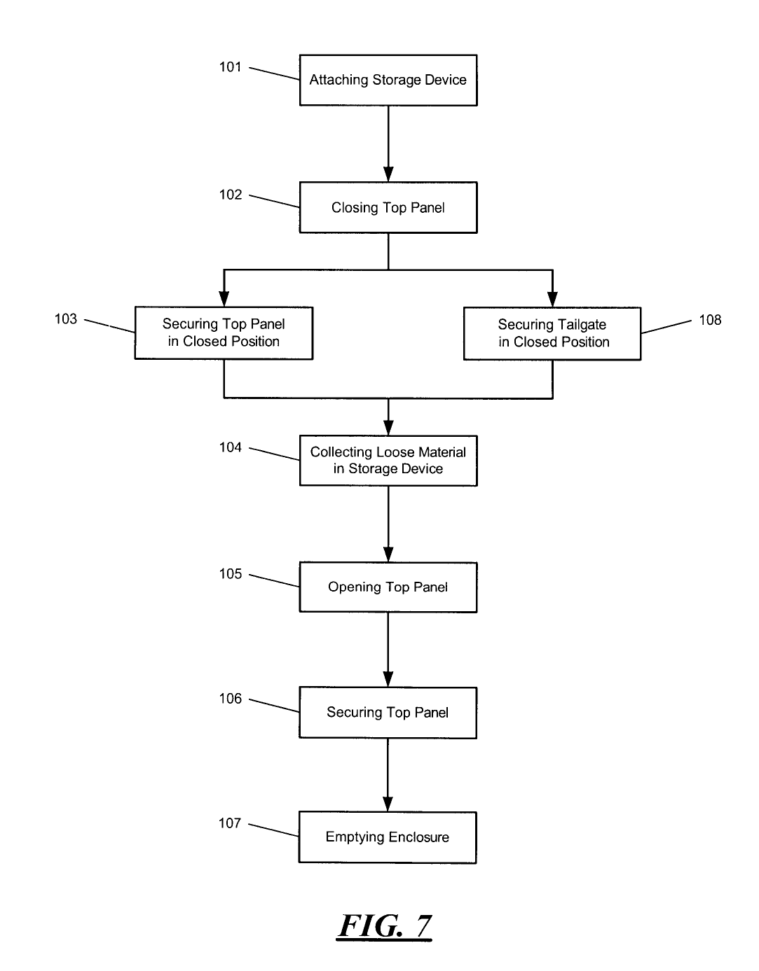

FIG. 7 is a flow chart that schematically illustrates the steps of the method for collecting, storing, and removing loose material from the loose material collecting device. The method comprises the steps of attaching to the towing vehicle 101 a collection and temporary storage device that includes an accordion-type top panel, orienting the accordion-type top panel in a closed position 102, securing the top panel to the flexible conduit 103 with the use of a closing device, possibly securing the tailgate to the enclosure in a closed position by securing a closing mechanism to the enclosure 108 if the enclosure has a tailgate otherwise securing the closing mechanism to the enclosure 108 directly, and collecting loose material in a volume defined by an enclosure 104. Once the loose material has been collected in the enclosure, the method also comprises the steps of orienting the accordion-type top panel in an open position to facilitate removal of the loose material from the enclosure 105, securing the accordion-type top panel in the open position 106, and finally removing the loose material from the enclosure 107.

It is understood by one of ordinary skill in the art that these steps correspond to the general steps to be taken to practice this method of this disclosure. Other auxiliary steps may be taken to conduct the collection and removal of the loose material but do not affect the validity and completeness of the disclosure of this general method of collection, storage, and removal of loose material from the device.

Persons of ordinary skill in the art appreciate that although the teachings of the disclosure have been illustrated in connection with certain embodiments and method, there is no intent to limit the invention to such embodiments and method. On the contrary, the intention of this application is to cover all modifications and embodiments falling fairly within the scope of the teachings of the disclosure.

We claim:

1. A device for collecting and temporarily storing loose material collected from the ground for use with a towing vehicle, the device comprising:
a head member for receiving the loose material from the towing vehicle;
an enclosure;
a loose material conduit for transferring the loose material from the head member to the enclosure; and
a turbine for creating suction in the head member and the loose material conduit, the turbine disposed between the head member and the enclosure, wherein the enclosure includes an accordion-type top panel.

2. The device of claim 1, wherein the accordion-type top panel can be retracted from a fully closed position to an open position.

3. The device of claim 2, wherein the accordion-type top panel in the closed position defines a volume that confines the loose material therein.

4. The device of claim 3, wherein a first lock secures the accordion-type top panel to the enclosure.

5. The device of claim 2, wherein the accordion-type top panel in the open position facilitates removal of the loose material by a user.

6. The device of claim 5, wherein a second lock secures the accordion-type top to the loose material conduit.

7. The device of claim 1, wherein the enclosure further comprises a mobile cart made of a frame, at least two wheels secured to the frame, and a towing arm secured to the frame; wherein the accordion-type top panel is mounted on top of the frame.

8. The device of claim 7, wherein the enclosure is movable about a wheel axis to facilitate removal of the loose material.

9. The device of claim 1, wherein the enclosure is made of a bottom panel, two side panels attached to the side edges of the bottom panel, a front panel attached to the front edge of the bottom panel, and a tailgate attached to the edge of the accordion-type panel.

10. The device of claim 1, wherein the enclosure is made of a bottom panel, two side panels attached to the side edges of the bottom panel, a front panel attached to the front edge of the bottom panel, and a back panel attached to the back edge of the bottom panel in a obtuse angle.

11. The device of claim 9, wherein the accordion-type top and the attached tailgate can be retracted from a fully closed position to an open position.

12. The device of claim 11, wherein a locking means secures the tailgate to the bottom panel.

13. The device of claim 10, wherein the locking means secures accordion-type top to the back panel.

14. The device of claim 1, wherein the accordion-type top panel further comprises at least an air opaque panel and a mesh-like panel.

15. A device for collecting and temporarily storing loose material collected from the ground for use with a towing vehicle, the device comprising:
a head member for receiving the loose material from the towing vehicle;
an enclosure made of a bottom panel, two side panels attached to side edges of the bottom panel, a front panel attached to a front edge of the bottom panel, a back panel attached to the back edge of a bottom panel, and an accordion-type top panel selectively configured with an upper free edge of the side, front, and back panels and including an opening;
a loose material conduit for transferring the loose material from the head member to the opening on the accordion-type top panel; and
a turbine for creating suction in the head member and the loose material conduit, the turbine disposed between the head member and the opening on the accordion-type top panel.

16. The device of claim 15, wherein the accordion-type top panel can be retracted from a closed position to an open position.

17. The device of claim 16, wherein the accordion-type top panel disposed in the closed position defines a volume for enclosing loose material therein.

18. The device of claim 17, wherein a first lock secures the accordion-type top panel in the closed position.

19. The device of claim 16, wherein the accordion-type top panel disposed in the open position facilitates removal of the loose material.

20. The device of claim 19, wherein a second lock secures the accordion-type top panel to the loose material conduit.

21. The device of claim 15, wherein the enclosure further comprises a mobile cart made of a frame, at least two wheels secured to the frame, and a towing arm secured to the frame.

22. The device of claim 21, wherein the enclosure is movable about a wheel axis to facilitate removal of the loose material.

23. The device of claim 16, wherein the accordion-type top panel comprises an air opaque panel and a mesh-like panel to regulate the flow of air through the enclosure.

24. A method of collecting, temporarily storing, and removing loose material collected from the ground with a towing vehicle, the method comprising the steps of:
attaching a collection and temporary storage device including an accordion-type top panel to the towing vehicle;
orienting the accordion-type top panel in a closed position;
securing the accordion-type top panel in the closed position;
collecting loose material in a volume defined by an enclosure;
orienting the accordion-type top panel in an open position to facilitate removal of the loose material in the enclosure;
securing the accordion-type top panel in the open position; and
removing the loose material from the enclosure.

25. A method of claim 24, wherein the step of securing the accordion-type top panel in the closed condition further includes securing a tailgate in the closed condition.
